(19) United States
(12) Patent Application Publication
(10) Pub. No.: US 2020/0411977 A1
(43) Pub. Date: Dec. 31, 2020

(54) Radiation Element and Antenna

(71) Applicant: AAC Technologies Pte. Ltd., Singapore City (SG)

(72) Inventor: Aqi Wang, Shenzhen (CN)

(21) Appl. No.: 16/996,937

(22) Filed: Aug. 19, 2020

Related U.S. Application Data
(63) Continuation of application No. PCT/CN2019/094047, filed on Jun. 30, 2019.

(51) Int. Cl. H01Q 1/38; H01Q 1/48

(52) U.S. Cl. CPC H01Q 1/38; H01Q 1/48

(57) ABSTRACT

The invention provides a radiation element and an antenna. The radiation element is formed by a square board through N-ORDER FRACTAL, wherein N is an integer and is greater than or equal to 3. First hollow grooves are separately formed in the middle parts of four edges of the square board towards the center of the square board. Second hollow grooves are separately formed in the middle parts of the four edges of each first order square towards the center of the first order square. Fractal of a structure formed after the second order fractal is continued to form the N-ORDER FRACTAL according to a second order fractal method. The radiation element provided by the invention has the advantage of small area at the same operating frequency.

### FIELD OF THE PRESENT DISCLOSURE

The invention relates to the field of antennas, in particular to a radiation element and an antenna using the radiation element.

### DESCRIPTION OF RELATED ART

Traditional radiation elements for antennas adopt a conventional geometry design, and the area of the radiation elements needs to be up to about half of wavelengths at operating frequencies. The area of the radiation elements is relatively large, and spacing distances between the radiation elements are limited during array forming, so that the isolation between the radiation elements is relatively poor and the overall performance of a system is reduced.

### SUMMARY OF THE INVENTION

One of the object of the invention is to provide a radiation element having the advantage of small area at the same operating frequency.

Thus, the invention provides a radiation element applied to an antenna, wherein the radiation element is formed by a square board through N-ORDER FRACTAL; where N is an integer and is greater than or equal to 3; and the N-ORDER FRACTAL comprises:

a. first order fractal, wherein first hollow grooves are separately formed in the middle parts of four edges of the square board towards the center of the square board; the length of each first hollow groove is the sum of ¼ of the edge length of the square board and ½ of the width of the first hollow groove; the square board is divided into four first order squares by four first hollow grooves; and

b. second order fractal, wherein second hollow grooves are separately formed in the middle parts of the four edges of each first order square towards the center of the first order square; the length of each second hollow groove is the sum of ¼ of the edge length of one first order square and ½ of the width of one second hollow groove; each first order square is divided into three second order squares by the four second hollow grooves; and

fractal of a structure formed after the second order fractal is continued to form the N-ORDER FRACTAL according to a second order fractal method.

The invention further provides an antenna, comprising:

a feed unit comprising a grounding layer and two differential feed circuits, wherein each differential feed circuit comprises an input end and two output ends;

a first radiation unit comprising the radiation element; and

a second radiation unit comprising four feeding elements and four grounding elements separately arranged apart from the feeding elements, wherein one end of each feeding element is connected with one output end of one differential feed circuit and the other end extends in a U form and is arranged apart from the radiation element to perform coupled feeding on the radiation element; one end of each grounding element is connected with the radiation element; and the other end is connected with the grounding layer.

Further, the feed unit further comprises a feed dielectric board; the differential feed circuits and the grounding layer are arranged on the feed dielectric board; one straight line in which two output ends of one differential feed circuit are positioned is perpendicular to the other straight line in which two output ends of the other differential feed circuit are positioned.

Further, the feed dielectric board comprises a first surface toward the second radiation unit and a second surface arranged opposite to the first surface; the grounding layer comprises a first grounding layer arranged on the first surface and a second grounding layer arranged on the second surface; the first grounding layer communicates with the second grounding layer; a clearance area is arranged on the first grounding layer or the second grounding layer; and the differential feed circuits are arranged in the clearance area.

Further, the clearance area is arranged on the second grounding layer; the differential feed circuits are arranged in the clearance area; four clearance grooves in one-to-one correspondence to four output ends of the two differential feed circuits are formed in the first grounding layer; welding plates are separately arranged in the clearance grooves; and the feeding elements are separately connected with the welding plates.

Further, the first radiation unit further comprises a first dielectric plate; the radiation element is arranged on the first dielectric plate; a round area formed by taking a midpoint of the radiation element as an origin and the distance from the midpoint to one first hollow groove as a radius is defined as a central area; and one ends of four grounding elements all are connected with the central area.

Further, the second radiation unit further comprises two second dielectric plates connected between the first dielectric plate and the feed dielectric board; the two second dielectric plates are arranged in a cross form; the two second dielectric plates are connected to form a connection part and extension parts extending towards four directions from the connection part; and one feeding element is arranged on each extension part.

Further, the four feeding elements are not opposite one another in pairs.

Further, one side of each second dielectric plate connected with the feed dielectric board is defined as a bottom part; one side of each second dielectric plate connected to the first dielectric plate is defined as a top part; and each feeding element comprises a first extension part extending from one bottom part to the top part, and a second extension part extending in a bent manner from one end, close to the top part, of the first extension part to the bottom part.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of an antenna provided by an exemplary embodiment of the invention.

FIG. 2 is an exploded view of the antenna in FIG. 1.

FIG. 3 is a partially enlarged view of Part A in FIG. 2.

FIG. 4 is a rear view of the antenna of the embodiment of the invention.

FIG. 5 is a partially enlarged view of Part B in FIG. 4.

FIG. 6 is an isometric view of a second radiation of the antenna.

FIG. 7 is an isomeric view of a first-order fractal of a radiation element of the antenna.

FIG. 8 is an isometric view of a second-order fractal of the radiation element.

FIG. 9 is an isometric view of the third-order fractal of the radiation element.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

It is to be noted that all directional indicators in the embodiment of the invention (for example, upper, lower, left, right, front, back, inner, outer, top, bottom and the like) are only used for explaining relative position relationships among parts in some special gesture (for example, shown in the drawings) and so on. If the special gesture changes, the directional indicators also change correspondingly.

It should also be noted that when an element is referred to as being “fixed” or “disposed” on another element, the element may be directly on the other element or there may be intervening elements at the same time. When an element is called “connected” to another element, it may be directly connected to the other element or there may be intervening elements at the same time.

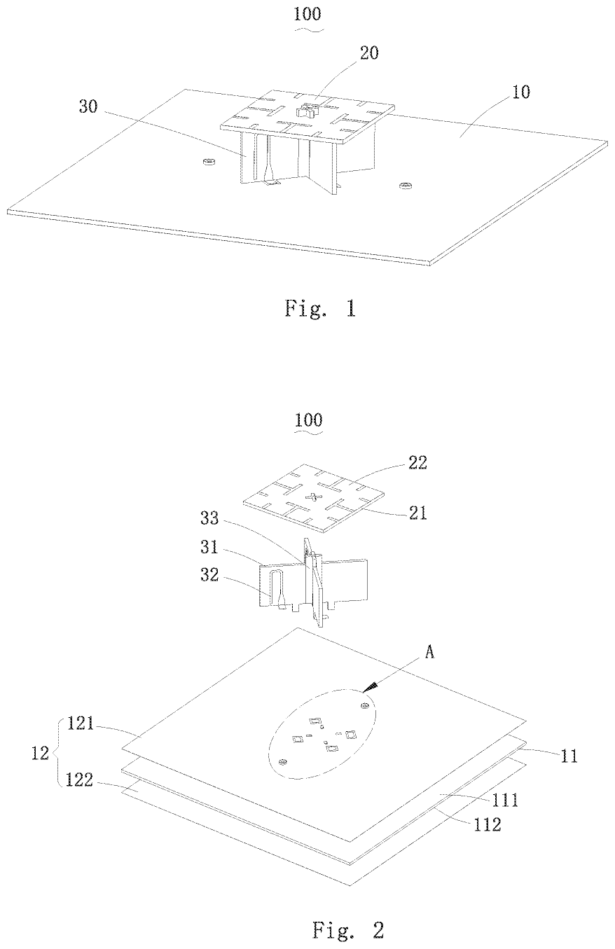

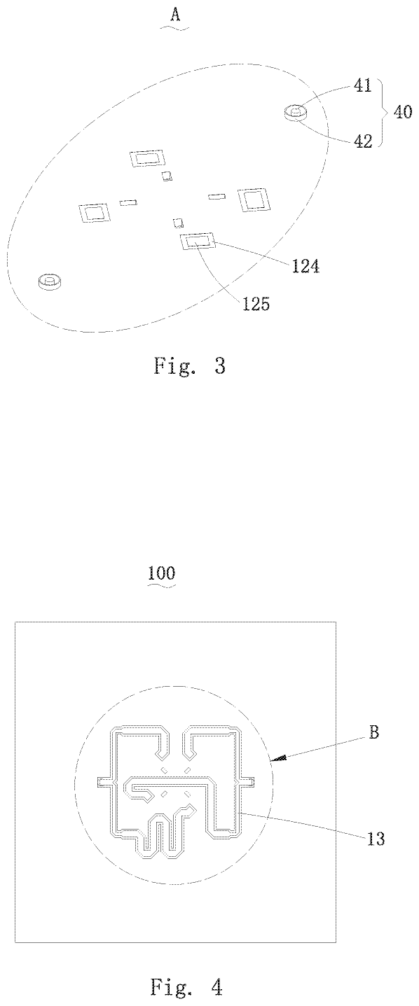

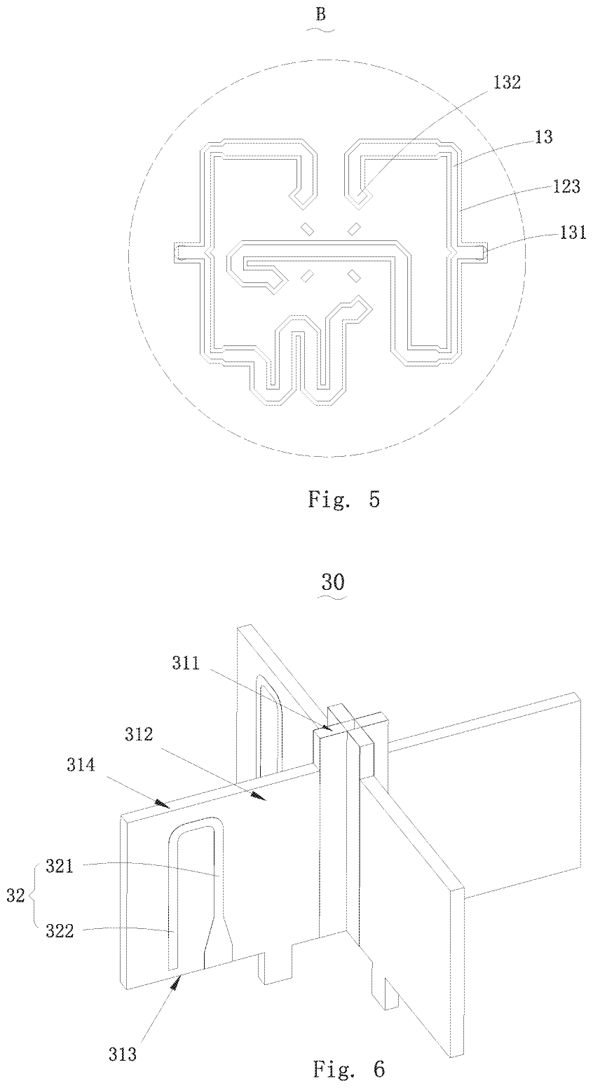

Referring to FIGS. 1-6, an antenna 100, provided by the embodiment of the invention, comprises:

a feed unit 10, wherein the feed unit 10 comprises a feed dielectric board 11, a grounding layer 12 and two differential feed circuits 13; and each differential feed circuit 13 comprises an input end 131 and two output ends 132;

a first radiation unit 20, wherein the first radiation unit 20 comprises a first dielectric plate 21 and a radiation element 22 arranged on the first dielectric plate 21; and

a second radiation unit 30, wherein the second radiation unit 30 comprises a second dielectric plate 31, four feeding elements 32 arranged on the second dielectric plate 31, and four grounding elements 33 arranged on the second dielectric plate 31 and arranged apart from the feeding elements 32 separately; one end of each feeding element 32 is connected with one output end 132 of one differential feed circuit 13 and the other end extends in a U form and is arranged apart from the radiation element 22 to perform coupled feeding on the radiation element 22; one end of each grounding element 33 is connected with the radiation element 22 and the other end is connected with the grounding layer 12.

When the antenna 100 is used, each feeding element 32 and the corresponding differential feed circuit 13 thereof form a linear polarization in one direction and the whole antenna 100 achieves orthogonal dual-polarization.

In the embodiment, through feeding of the arranged feeding elements 32 and radiation element 22 in a coupled feeding manner, the number of welding points can be reduced and passive intermodulation (PIM) features of a system are improved. Through the arranged feeding elements 32 extending in a U form, on one hand, electrical lengths of the feeding elements 32 can be effectively prolonged; and on the other hand, a profile height of the antenna 100 can be reduced, the requirements of customers on miniaturization of a base station are met and the market competitiveness is improved. Through feeding of the feeding elements 32 in a differential feeding manner, the polarization purity of the antenna 100 is improved.

It should be noted that the antenna 100 may not require the first dielectric plate 21 and the second dielectric plates 31 and may require only the grounding elements 33 to play a support role in the radiation element 22.

As an improvement of the embodiment, one straight line in which two output ends 132 of one differential feed circuit 13 are positioned is perpendicular to the other straight line in which two output ends 132 of the other differential feed circuit 13 are positioned.

As an improvement of the embodiment, the feed dielectric board 11 comprises a first surface 111 toward the second radiation unit 30 and a second surface 112 arranged opposite to the first surface 111. The grounding layer 12 comprises a first grounding layer 121 arranged on the first surface 111 and a second grounding layer 122 arranged on the second surface 112. The first grounding layer 121 communicates with the second grounding layer 122. A clearance area 123 is arranged on the second grounding layer 122. The differential feed circuits 13 are arranged in the clearance area 123. It will be understood that the positions of the differential feed circuits 13 are not limited to the second grounding layer 122, for example, the clearance area 123 is arranged on the first grounding layer 121, and the differential feed circuits 13 can also be arranged on the first grounding layer 121. Furthermore, the grounding layer 12 is limited to the arrangement way, for example, the grounding layer 12 may include only the first grounding layer 121 or the second grounding layer 122. Specifically, the first grounding layer 121 can communicate with the second grounding layer 122 through a metallized through hole.

As an improvement of the embodiment, four clearance grooves 124 in one-to-one correspondence to four output ends 132 of the two differential feed circuits 13 are formed in the first grounding layer 122. Welding plates 125 are separately arranged in the clearance grooves 124. The feeding elements 32 are separately connected with the welding plates 125. The welding plates 125 are connected with the output ends 132 of the differential feed circuits 13 through the metalized through hole.

As an improvement of the embodiment, the input end 131 of each differential feed circuit 13 is connected with a coaxial connector 40. The coaxial connector 40 comprises a first conductive member 41 and a second conductive member 42 coaxially arranged apart from the first conductive member 41. The first conductive member 41 is electrically connected with the input ends 131 of the differential feed circuits 13. The second conductive member 42 is connected with the first grounding layer 121.

As an improvement of the embodiment, the second dielectric plates 31 are connected between the feed dielectric board 11 and the first dielectric plate 21. Two second dielectric plates 31 are arranged. The two second dielectric plates 31 are arranged in a cross form. The two second dielectric plates 31 are connected to form a connection part 311 and extension parts 312 extending towards four directions from the connection part 311. One feeding element 32 is arranged on each extension part 312.

As an improvement of the embodiment, the four feeding elements 32 are not opposite one another in pairs.

As an improvement of the embodiment, one side, connected with the feed dielectric board 11, of each second dielectric plate 31 is defined as a bottom part 313; one side, connected to the first dielectric plate 21, of each second dielectric plate 31, is defined as a top part 314; and each feeding element 32 comprises a first extension part 321 extending from one bottom part 313 to the top part 314, and a second extension part 322 extending in a bent manner from one end, close to the top part 314, of the first extension part 321 to the bottom part 313. In the embodiment, each second extension part 322 is positioned at one side, close to the connection part 311, of the corresponding first extension part 321. In other embodiments, each second extension part 322 can be arranged at one side, far away from the connection part 311, of the corresponding first extension part 321 and can be specifically arranged according to the actual design requirements.

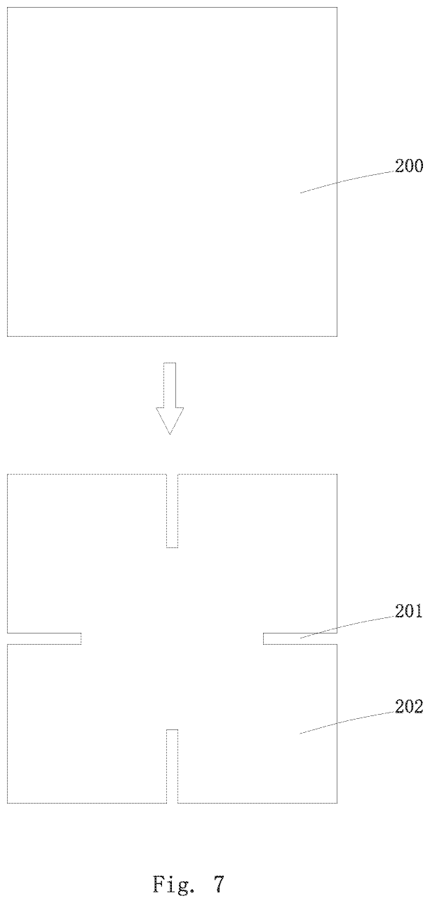

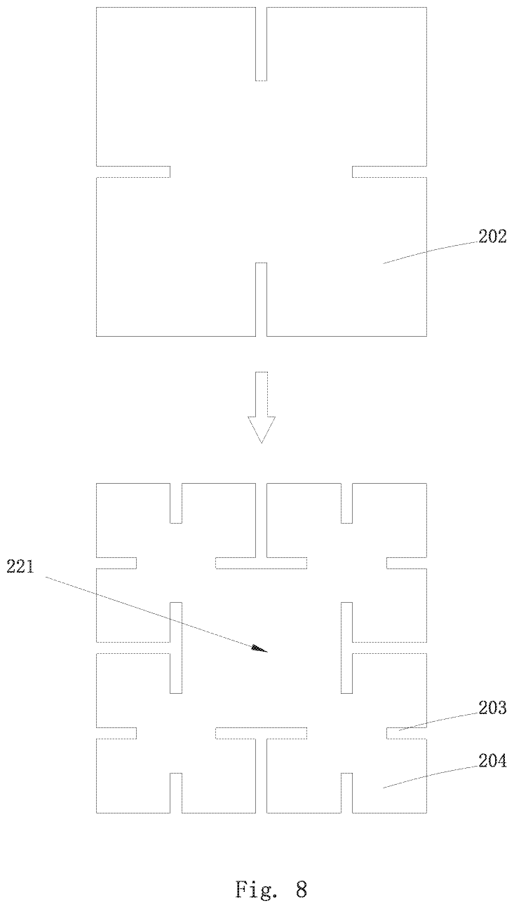

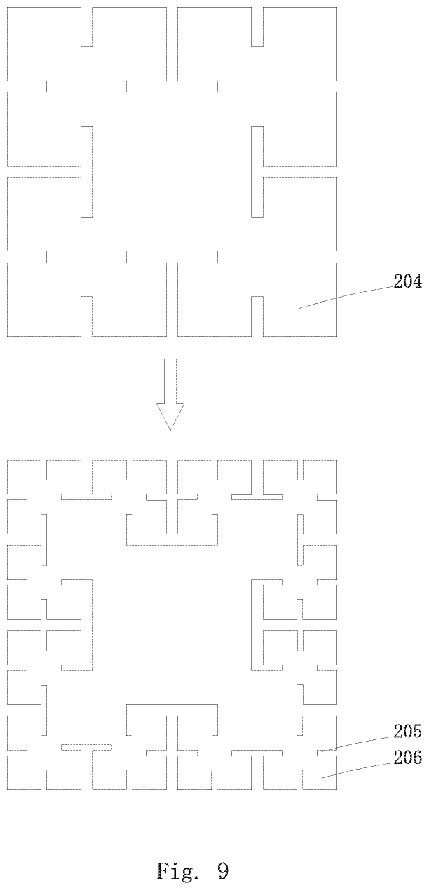

Referring to FIGS. 7-9, as an improvement of the embodiment, the radiation element 22 is formed by a square board 200 through N-ORDER FRACTAL. N is an integer and is greater than or equal to 3. The N-ORDER FRACTAL specifically comprises

a. first order fractal, wherein first hollow grooves 201 are separately formed in the middle parts of four edges of the square board 200 towards the center of the square board 200; the length of each first hollow groove 201 is the sum of ¼ of the edge length of the square board 200 and ½ of the width of the first hollow groove; the square board 200 is divided into four first order squares 202 by four first hollow grooves 201;

b. second order fractal, wherein second hollow grooves 203 are separately formed in the middle parts of the four edges of each first order square 202 towards the center of the first order square 202; the length of each second hollow groove 203 is the sum of ¼ of the edge length of one first order square 202 and ½ of the width of one first hollow groove; each first order square 202 is divided into three second order squares 204 by the four second hollow grooves 203;

c. third order fractal, wherein third hollow grooves 205 are separately formed in the middle parts of the four edges of each second order square 204 towards the center of the second order square 204; the length of each second hollow groove 205 is ¼ of the edge length of one second order square 204; each second order square 204 is divided into three third order squares 206 by four third hollow grooves 205; and, fractal of a structure formed after the second order fractal is continued to form N+2 order fractal according to a second order fractal method.

According to the radiation element 22 in the embodiment, after the fractal is performed through the fractal method, a radiation edge length of the radiation element 22 under the same area can be extended, and an operating frequency of the radiation element 22 under the same area is lower. That is, at the same operating frequency, the area of the radiation element 22 after the fractal is smaller than that of an ordinary radiation element, thereby playing a role in reducing the volume of the antenna 100. Therefore, under the same array forming structure, the distance between the antennas 100 is increased, the isolation between the antennas 100 is improved and the target of optimizing the performance of the system is achieved. Tests show that, after the second order fractal is performed through the fractal method, at the same operating frequency, the area of the radiation element 22 can be reduced by about 20%; and the higher the order of the fractal is, the smaller the area can be at the same operating frequency.

As an improvement of the embodiment, a round area formed by taking a midpoint of the radiation element 22 as an origin and the distance from the midpoint to one first hollow groove 201 as a radius is defined as a central area 221; and one ends of the four grounding elements 33 all are connected with the central area 221.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A radiation element applied to an antenna, wherein the radiation element is formed by a square board through N-ORDER FRACTAL; where N is an integer and is greater than or equal to 3; and the N-ORDER FRACTAL comprises:
a. first order fractal, wherein first hollow grooves are separately formed in the middle parts of four edges of the square board towards the center of the square board; the length of each first hollow groove is the sum of ¼ of the edge length of the square board and ½ of the width of the first hollow groove; the square board is divided into four first order squares by four first hollow grooves; and
b. second order fractal, wherein second hollow grooves are separately formed in the middle parts of the four edges of each first order square towards the center of the first order square; the length of each second hollow groove is the sum of ¼ of the edge length of one first order square and ½ of the width of one second hollow groove; each first order square is divided into three second order squares by the four second hollow grooves; and
fractal of a structure formed after the second order fractal is continued to form the N-ORDER FRACTAL according to a second order fractal method.

2. An antenna, comprising:
a feed unit comprising a grounding layer and two differential feed circuits, wherein each differential feed circuit comprises an input end and two output ends;
a first radiation unit comprising the radiation element; and
a second radiation unit comprising four feeding elements and four grounding elements separately arranged apart from the feeding elements, wherein one end of each feeding element is connected with one output end of one differential feed circuit and the other end extends in a U form and is arranged apart from the radiation element to perform coupled feeding on the radiation element; one end of each grounding element is connected with the radiation element; and the other end is connected with the grounding layer.

3. The antenna as described in claim 2, wherein the feed unit further comprises a feed dielectric board; the differential feed circuits and the grounding layer are arranged on the feed dielectric board; one straight line in which two output ends of one differential feed circuit are positioned is perpendicular to the other straight line in which two output ends of the other differential feed circuit are positioned.

4. The antenna as described in claim 3, wherein the feed dielectric board comprises a first surface toward the second radiation unit and a second surface arranged opposite to the first surface; the grounding layer comprises a first grounding layer arranged on the first surface and a second grounding layer arranged on the second surface; the first grounding layer communicates with the second grounding layer; a clearance area is arranged on the first grounding layer or the second grounding layer; and the differential feed circuits are arranged in the clearance area.

5. The antenna as described in claim 4, wherein the clearance area is arranged on the second grounding layer; the differential feed circuits are arranged in the clearance area; four clearance grooves in one-to-one correspondence to four output ends of the two differential feed circuits are formed in the first grounding layer; welding plates are separately arranged in the clearance grooves; and the feeding elements are separately connected with the welding plates.

6. The antenna as described in claim 3, wherein the first radiation unit further comprises a first dielectric plate; the radiation element is arranged on the first dielectric plate; a round area formed by taking a midpoint of the radiation element as an origin and the distance from the midpoint to one first hollow groove as a radius is defined as a central area; and one ends of four grounding elements all are connected with the central area.

7. The antenna as described in claim 6, wherein the second radiation unit further comprises two second dielectric plates connected between the first dielectric plate and the feed dielectric board; the two second dielectric plates are arranged in a cross form; the two second dielectric plates are connected to form a connection part and extension parts extending towards four directions from the connection part; and one feeding element is arranged on each extension part.

8. The antenna as described in claim 7, wherein the four feeding elements are not opposite one another in pairs.

9. The antenna as described in claim 7, wherein one side of each second dielectric plate connected with the feed dielectric board is defined as a bottom part; one side of each second dielectric plate connected to the first dielectric plate is defined as a top part; and each feeding element comprises a first extension part extending from one bottom part to the top part, and a second extension part extending in a bent manner from one end, close to the top part, of the first extension part to the bottom part.
